(19) United States
(12) Patent Application Publication
(10) Pub. No.: US 2003/0169857 A1
(43) Pub. Date: Sep. 11, 2003

(54) Subscriber activated calling party voice-print identification system for voice message screening

(75) Inventors: A. Akhteruzzaman, Naperville, IL (US); Maureen Brigid Gallagher, Naperville, IL (US); Paul Raymond Sand, Woodridge, IL (US); Richard Grant Sparber, Wheaton, IL (US); Claudis L. Young, Aurora, IL (US)

Correspondence Address: PATTON BOGGS, PO BOX 270930, LOUISVILLE, CO, 80027, US

(73) Assignee: Lucent Technologies Inc.

(21) Appl. No.: 10/092,244

(22) Filed: Mar. 6, 2002

(51) Int. Cl. H04M 1/64

(52) U.S. Cl. 379/88.01

(57) ABSTRACT

The voice-print based voice message screening system enables a calling party to leave a voice message for the identified subscriber without the need to input any additional information. When the subscriber receives a voice message from a calling party, the subscriber can elect to add the calling party to the subscriber's calling party screening list by activating the voice-print based voice message screening system to register the calling party. The voice-print based voice message screening system stores data indicative of the subscriber's listed directory number, the calling party's number, the identity of the calling party as characterized by the subscriber, and also stores a small set of determined speech characteristics to identify the calling party. On a subsequently received call for the subscriber, the voice-print based voice message screening system analyzes the calling party's voice based on one or more parameters that can be managed by the subscriber to identify the calling party.

### FIELD OF THE INVENTION

This invention relates to voice message storage systems and, in particular, to a subscriber initiated calling party voice-print identification process that automatically identifies a calling party via a voice-print to enable the subscriber to screen their voice messages.

### PROBLEM

It is a problem in voice messaging systems for a subscriber to screen their voice messages without the expenditure of a significant amount of time and effort or the expenditure of a significant amount of voice message system resources. This problem is compounded by the fact that the calling party is unlikely to provide any identification information, even if prompted to do so. Thus, voice message systems typically require the subscriber to sequence through each voice message to personally determine the identity of the calling party.

The field of calling party identification systems includes U.S. Pat. No. 5,901,203 which discloses a computer-based system for identifying an unidentified caller. This system requires every calling party to speak an utterance, such as a password, name or other standard phrase, which is used by the system for identification of the calling party. Thus, when a calling party accesses the system, they are prompted to provide an utterance. If this utterance matches one of the previously stored utterances, the system automatically identifies the calling party and processes the incoming call by providing the calling party with a number of call direction options. If the calling party has not previously accessed the system, they are prompted to provide additional identification information which is then stored with the utterance for future call screening. If the system fails to match the received utterance with any stored utterance and the calling party has previously registered with the system, the called party can update the call screening database to refine its accuracy of operation.

U.S. Pat. No. 5,940,476 is a variation of the above-described calling party identification system and discloses a voice mail system that uses a computer-based system for identifying an unidentified caller. This voice mail system requires every calling party to speak an utterance, such as a password, name or other standard phrase, which is used by the voice mail system for identification of the calling party. Thus, when a calling party accesses the voice mail system, they are prompted to provide an utterance. If this utterance matches one of the previously stored utterances, the voice mail system automatically identifies the calling party and processes the incoming call by providing the calling party with a number of call direction options. If the calling party has not previously accessed the voice mail system, they are prompted to provide additional identification information which is then stored with the utterance for future call screening. If the voice mail system fails to match the received utterance with any stored utterance and the calling party has previously registered with the voice mail system, the called party can update the call screening database to refine its accuracy of operation.

Therefore, these above-noted calling party identification systems require every calling party to provide an utterance, which must be remembered for use in subsequent calls, before their incoming call is processed. In addition, these systems compare a received utterance with all previously stored utterances in order to identify a match. The processing burden imposed by such a paradigm on every incoming call becomes impractical in a number of situations: for systems where a large number of subscribers are served, for instances where the calling party is typically an infrequent or one time caller, for systems that require rapid processing of the incoming call for quality of service purposes, for instances where the calling party fails to provide an utterance. Thus, these calling party identification systems fail to provide a caller identification service that is efficient and practical.

### SOLUTION

The subscriber activated calling party voice-print identification system for voice message screening (termed “voice-print based voice message screening system” herein) solves the above-described problems and achieves a technical advance in the art by enabling a subscriber to activate a voice-print identification process for selected calling parties to thereby enable the subscriber to be advised when the identified calling party subsequently leaves a voice message for the subscriber. The voice-print based voice message screening system enables a calling party to leave a voice message for the identified subscriber without the need to input any additional information. When the subscriber receives a voice message from a calling party, the subscriber can elect to add the calling party to the subscriber's calling party screening list by activating the voice-print based voice message screening system to register the calling party. The voice-print based voice message screening system stores data indicative of the subscriber's listed directory number, the calling party's number, the identity of the calling party as characterized by the subscriber, and also stores a small set of determined speech characteristics to identify the calling party. On a subsequently received call for the subscriber, the voice-print based voice message screening system analyzes the calling party's voice based on one or more parameters that can be managed by the subscriber, including: called party number, calling party number, determined speech characteristics. In this manner, the processing of incoming calls is reduced to serve only those instances where the subscriber wishes to have the calling party identified.

### BRIEF DESCRIPTION OF THE DRAWING

FIG. 1 illustrates in block diagram for the voice-print based voice message screening system and a typical environment in which it is operational;

FIG. 2 illustrates in flow diagram form the operation of the voice-print based voice message screening system in response to a subscriber initiated request to add a calling party to the voice-print screening process; and

FIG. 3 illustrates in flow diagram form the operation of the voice-print based voice message screening system in screening calls in response to receipt of an incoming call to the subscriber's voice message system.

### DETAILED DESCRIPTION

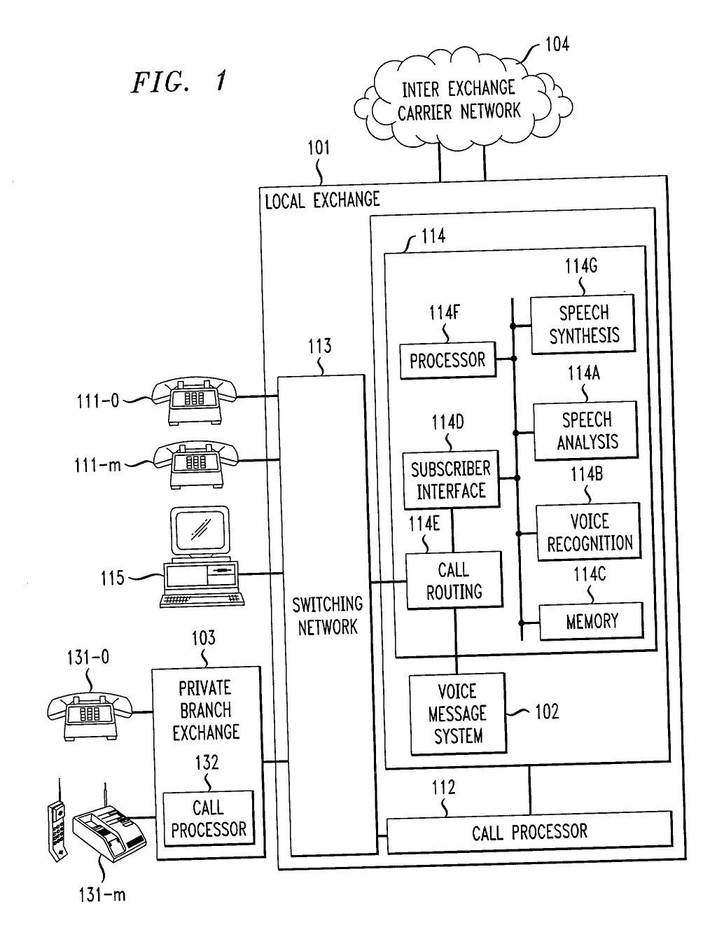

FIG. 1 illustrates in block diagram for the voice-print based voice message screening system 114 and a typical environment in which it is operational. The subscribers are typically equipped with one or more of a personal computer 115, hand held computing device (not shown), telephone station set 111-0, or other subscriber communication device, collectively termed “subscriber terminal equipment” herein. The subscriber's terminal equipment 111-0 is generally served by the Public Switched Telephone Network (PSTN) which consists of an interexchange carrier network 104 that inter-connects a plurality of Local Exchange Systems, such as Local Exchange System 101, each serving a plurality of subscriber terminal equipment (111-0 to 111-m) under control of an associated call processor 112. Alternatively, the subscriber can be served by a Private Branch eXchange (PBX) 103 which is used to provide communication services to a plurality of subscriber terminal equipment (131-0 to 131-m) under control of a call processor 132 and interconnect the subscriber terminal equipment via trunks to the Public Switched Telephone Network. The physical connection that supports this communication connection is typically effected from subscriber's terminal equipment 110-0 through the Local Exchange System 101 of the Public Switched Telephone Network (PSTN).

The Local Exchange System 101, or alternatively Private Branch Exchange 103, includes or is connected to a voice message system 102 that provides voice messaging service for the subscribers served by the subscriber terminal equipment 111-0 to 111-m. Also included in Local Exchange System 101 is the present voice-print based voice message screening system 114 that is part of voice message system 102 or alternatively is connected to and operates in conjunction with voice message system 102. The voice-print based voice message screening system 114 comprises: a speech analysis system 114A, voice recognition system 114B, memory 114C, subscriber interface 114D, call routing system 114E, processor 114F, and optionally speech synthesis system 114G.

Calling Party Registration for Voice Message Screening

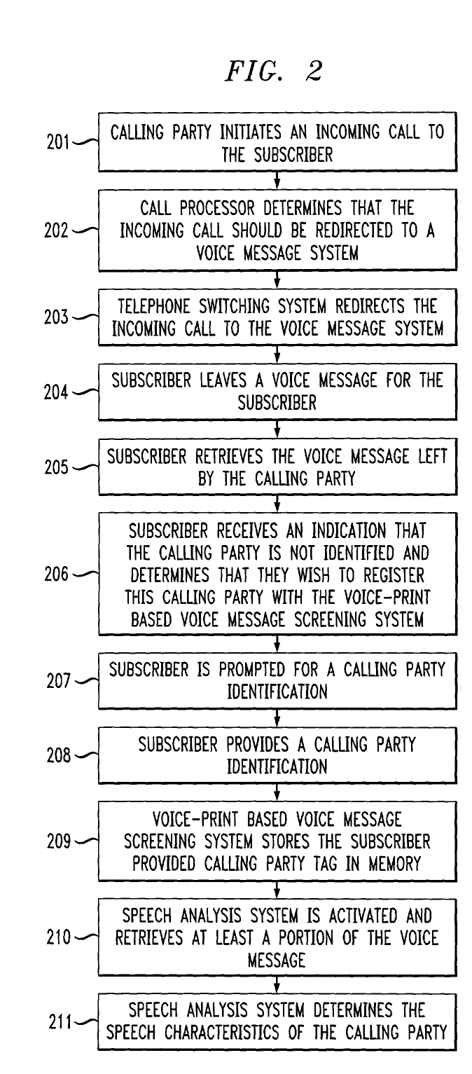

FIG. 2 illustrates in flow diagram form the operation of the voice-print based voice message screening system 114 in response to a subscriber initiated request to add a calling party to the voice-print screening process. For the purpose of this description, the subscriber is assumed to have an assigned telephone station set 111-0. The telephone number of the telephone station set 111-0 is termed the subscriber's listed directory number herein to indicate that this is the telephone number that is used by the Public Switched Telephone Network to identify the subscriber's service location and to contact the subscriber. A typical example of a subscriber listed directory number is the subscriber's home telephone number.

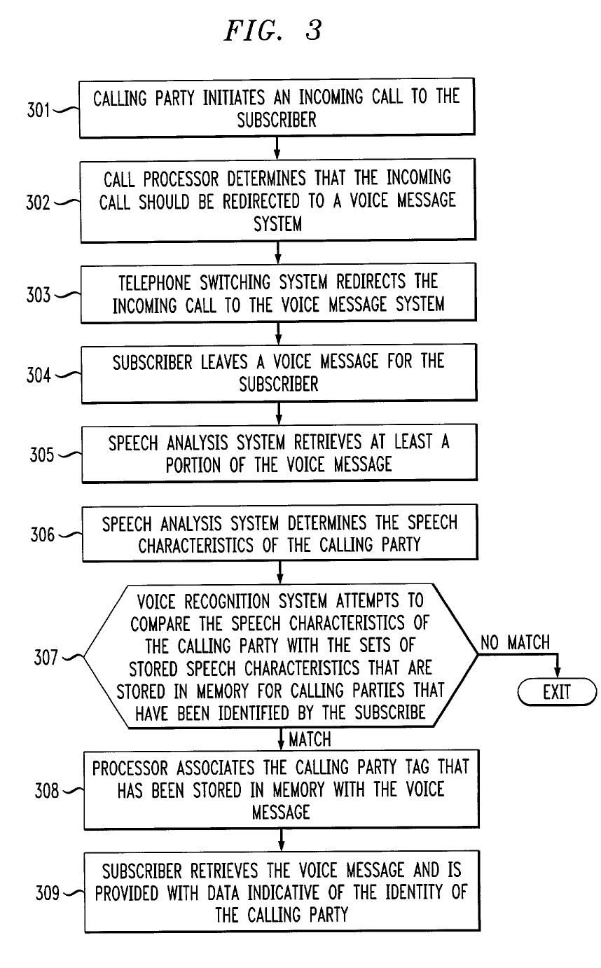

At step 201, the calling party initiates an incoming call to the subscriber by going off hook on their telephone station set 131-0 and dialing the number of the subscriber. The call processor 132 that serves the calling party's telephone station set 131-0 extends the call origination to the telephone switching system 101 that serves the subscriber. At step 202, the call processor 112 in the telephone switching system 101 that serves the subscriber determines that the incoming call should be redirected to a voice message system 102 because the subscriber does not answer after a predetermined number of rings, the subscriber's call forwarding feature is activated, the calling party number is identified for call redirection based on calling party filtering, and the like. At step 203, the telephone switching system 101 that serves the subscriber redirects the incoming call via switching network 113 to the voice message system 102 via the call redirection module 114E of the voice-print based voice message screening system 114, where the subscriber at step 204 leaves a voice message for the subscriber on the voice message system 102 and hangs up. Assume that the calling party has not been previously registered by the subscriber, and the call screening process of FIG. 3, described below, fails to match the calling party with any previously registered calling parties for the subscriber.

At step 205, the subscriber retrieves the voice message left by the calling party by dialing the access number of the voice message system 102 and being connected via switching network 113 to the voice message system 102 via the call redirection module 114E of the voice-print based voice message screening system 114. At step 206, the subscriber receives an indication that the calling party is not identified and determines that they wish to register this calling party with the voice-print based voice message screening system 114 for automatic identification for future messages left by the calling party. At step 207, the subscriber is connected via the call redirection module 114E to the subscriber interface 114D of the voice-print based voice message screening system 114 and processor 114F prompts the subscriber for a calling party identification for use in future message waiting indications for the subscriber. The subscriber at step 208 provides a calling party identification via voice input or keypad operation of subscriber telephone set 131-0 to assign a tag to the calling party. The voice-print based voice message screening system 114 stores the subscriber provided calling party tag in memory 114C at step 209 and processor 114F schedules the voice message for analysis. The speech analysis system 114A of the voice-print based voice message screening system 114 is activated by processor 114F at step 210 and retrieves at least a portion of the voice message to determine, at step 211, the speech characteristics of the calling party, which are stored in memory 114C in conjunction with the calling party tag. The determination of the calling party speech characteristics is accomplished by the use of a conventional speech analysis system 114A which outputs a standardized set of data that defines predetermined characteristics of the calling party's speech.

Operation of the Voice-Print Based Voice Message Screening System

FIG. 3 illustrates in flow diagram form the operation of the voice-print based voice message screening system 114 in screening calls in response to receipt of an incoming call to the subscriber's voice message system 102. At step 301, the calling party initiates an incoming call to the subscriber by going off hook on their telephone station set 131-0 and dialing the number of the subscriber. The call processor 132 that serves the calling party's telephone station set 131-0 extends the call origination to the telephone switching system 101 that serves the subscriber. At step 302, the telephone switching system 101 that serves the subscriber determines that the incoming call should be redirected to a voice message system 102 because the subscriber does not answer after a predetermined number of rings, the subscriber's call forwarding feature is activated, the calling party number is identified for call redirection based on calling party filtering, and the like. At step 303, the telephone switching system 101 that serves the subscriber redirects the incoming call to the voice message system 102 via the call redirection module 114E of the voice-print based voice message screening system 114, where the subscriber at step 304 leaves a voice message for the subscriber and hangs up. At step 305, the processor 114F activates the speech analysis system 114A of the voice-print based voice message screening system 114 to retrieve at least a portion of the voice message stored by the calling party and determines, at step 306, the speech characteristics of the calling party. The voice recognition system 114B of the voice-print based voice message screening system 114 at step 307 attempts to compare the speech characteristics of the calling party, as determined by the speech analysis system 114A, with the sets of stored speech characteristics that are stored in memory 114C for calling parties that have been identified by the subscriber. If there is a match determined by the voice recognition system 114B, at step 307 the processor 114F of the voice-print based voice message screening system 114 associates the calling party tag that has been stored in memory 114C by the subscriber for this calling party with the voice message. If no match occurs, processing terminates.

When the subscriber later activates the voice message system 102 to retrieve the voice message left by the calling party at step 308, the subscriber is provided with data indicative of the identity of the calling party. This can be an audible response pre-pended to the voice message so the subscriber can screen the incoming message. If the subscriber retrieves a text version of the voice message or has a display telephone station set, the voice-print based voice message screening system 114 outputs a text version of the subscriber provided calling party tag to provide the subscriber with a text-based calling party identification.

In processing the voice message at step 307, the voice-print based voice message screening system 114 can parse the sets of speech characteristics stored in memory in a number of ways. The sets of speech characteristics stored in memory 114C are typically parsed by subscriber identity and can further be parsed by calling party number to reduce the processing required to identify the calling party.

Alternative Features

The voice-print based voice message screening system 114 can provide additional features that are associated with the identification of the calling party via voice-print identification. In particular, the e-mail address of the calling party can be stored in memory 114C, along with the fax number of the calling party. Any text-based messages received from the calling party in these modes and identified by the voice-print based voice message screening system matching the stored e-mail address or fax number can be delivered to the subscriber as a voice message, with the calling party identification as noted above.

### SUMMARY

The voice-print based voice message screening system enables a calling party to leave a voice message for the identified subscriber without the need for the calling party to input any additional information. When the subscriber receives a voice message from a calling party, the subscriber can elect to add the calling party to the subscriber's calling party screening list by activating the voice-print based voice message screening system to register the calling party in an off-line processing mode.

What is claimed:

1. A voice-print based voice message screening system for providing subscribers with the identity of calling parties who leave voice messages on a voice message system, comprising:
speech analysis means, responsive to receipt of a voice message from a calling party and directed to a subscriber served by said voice message system, for determining speech characteristics of said calling party;
speech characteristic matching means for comparing said determined speech characteristics of said voice message with speech characteristics previously stored in a memory by said subscriber for a plurality of calling parties; and
calling party identification means, responsive to a match of said determined speech characteristics of said voice message with a one of said speech characteristics previously stored in said memory by said subscriber for a plurality of calling parties, for identifying said calling party to said subscriber when said subscriber retrieves said voice message.

2. The voice-print based voice message screening system of claim 1 further comprising:
subscriber interface means, responsive to a failure to match said determined speech characteristics of said voice message with a one of said speech characteristics previously stored in said memory by said subscriber for a plurality of calling parties, for identifying said failure to match to said subscriber when said subscriber retrieves said voice message.

3. The voice-print based voice message screening system of claim 2 further comprising:
calling party registration means, responsive to said subscriber interface means and said subscriber initiating calling party registration, for activating said speech analysis means to determine speech characteristics of said calling party from said stored voice message; and
data storage means for storing said determined speech characteristics of said calling party in said memory.

4. The voice-print based voice message screening system of claim 3 further comprising:
calling party identification means for storing subscriber provided indicia, in association with said stored determined speech characteristics of said calling party, to identify said calling party.

5. The voice-print based voice message screening system of claim 1 wherein said speech characteristic matching means is responsive to a received voice message for retrieving speech characteristics previously stored in a memory by said subscriber for both a plurality of calling parties and also matching a telephone number of said calling party.

6. The voice-print based voice message screening system of claim 1 wherein said speech analysis means retrieves a segment of said voice message for determining speech characteristics of said calling party.

7. The voice-print based voice message screening system of claim 1 further comprising:
incoming call routing means for directly connecting said calling party to said voice message system for storage of a voice message therein absent intervening processing.

8. The voice-print based voice message screening system of claim 7 further comprising:
scheduling means, responsive to storage of said voice message by said calling party, for scheduling activation of said speech analysis means to process said stored voice message to determine speech characteristics of said calling party.

9. A method of voice-print based voice message screening for providing subscribers with the identity of calling parties who leave voice messages on a voice message system, comprising the steps of: determining, in response to receipt of a voice message from a calling party and directed to a subscriber served by said voice message system, speech characteristics of said calling party;
comparing said determined speech characteristics of said voice message with speech characteristics previously stored in a memory by said subscriber for a plurality of calling parties; and
identifying, in response to a match of said determined speech characteristics of said voice message with a one of said speech characteristics previously stored in said memory by said subscriber for a plurality of calling parties, said calling party to said subscriber when said subscriber retrieves said voice message.

10. The method of voice-print based voice message screening of claim 9 further comprising the step of:
identifying, in response to a failure to match said determined speech characteristics of said voice message with a one of said speech characteristics previously stored in said memory by said subscriber for a plurality of calling parties, said failure to match to said subscriber when said subscriber retrieves said voice message.

11. The method of voice-print based voice message screening of claim 10 further comprising the steps of:
activating, in response to said step of identifying said failure to match and said subscriber initiating calling party registration, said step of determining to determine speech characteristics of said calling party from said stored voice message; and
storing said determined speech characteristics of said calling party in said memory.

12. The method of voice-print based voice message screening of claim 11 further comprising the step of:
storing subscriber provided indicia, in association with said stored determined speech characteristics of said calling party, to identify said calling party.

13. The method of voice-print based voice message screening of claim 9 wherein said step of comparing said speech characteristics is responsive to a received voice message for retrieving speech characteristics previously stored in a memory by said subscriber for both a plurality of calling parties and also matching a telephone number of said calling party.

14. The method of voice-print based voice message screening of claim 9 wherein said step of determining retrieves a segment of said voice message for determining speech characteristics of said calling party.

15. The method of voice-print based voice message screening of claim 9 further comprising the step of:
directly connecting said calling party to said voice message system for storage of a voice message therein absent intervening processing.

16. The method of voice-print based voice message screening of claim 15 further comprising the step of:
scheduling, in response to storage of said voice message by said calling party, activation of said step of determining to process said stored voice message to determine speech characteristics of said calling party.
